(19) United States
(12) Patent Application Publication
(10) Pub. No.: US 2009/0074161 A1
(43) Pub. Date: Mar. 19, 2009

(54) TELEPHONE DEVICE

(76) Inventor: Kenichi Kamiya, Tokyo (JP)

Correspondence Address: NEC CORPORATION OF AMERICA, 6535 N. STATE HWY 161, IRVING, TX, 75039, US

(21) Appl. No.: 12/281,512

(22) PCT Filed: May 23, 2007
(86) PCT No.: PCT/JP2007/060481

§ 371 Date: Sep. 3, 2008

(30) Foreign Application Priority Data
May 25, 2006 (JP) 2006-145098

(51) Int. Cl. H04M 11/00; G06F 9/445

(52) U.S. Cl. 379/93.06; 717/178

(57) ABSTRACT

In a telephone device including telephone operation section (5a) on panel surface (5) at an upper part of a housing forming main body (4), the housing is constructed so that receiver section (1) can be placed thereon and is also constructed in the form of a desktop telephone device that can be placed on a desk. The telephone device includes computer section (3) connected to telephone operation section (5a) via a predetermined interface, computer section (3) including an operating system for a personal computer or a PDA to install an IP softphone that performs communication according to the Internet Protocol, and providing a communication and phone call function via the IP softphone.

### TECHNICAL FIELD

The present invention relates to a telephone device, and specifically relates to a telephone device used in the state of being placed on a desk.

### BACKGROUND ART

In recent years, the use of IP telephones has been growing in homes and companies, etc. In such circumstances, three main types of terminals have been used as IP telephone terminals for users. The first is an IP telephone device in the form of a conventional desktop telephone device (which is an IP multifunctional telephone device in many cases), the second is a softphone which is software installed for use in a personal computer, etc., and the third is a mobile IP telephone terminal which provides communication via a wireless LAN.

From among these, a softphone is particularly excellent in flexibility and linking capability because it is software. In other words, it can be improved to meet the changing needs (market changes and individual demands of different users) more easily than hardware, and also, it can easily be linked with general business software other than the telephone function.

Japanese Patent Laid-Open No. 2003-259000 describes a telephone device that can download an application program from a server thereto to provide a function using the downloaded application program.

Japanese Patent Laid-Open No. 1994-176041 describes a telephone device having a processor and a memory function. In this telephone device, the call function that uses the telephone and the computer function that uses the processor, etc., can be switched by means of an automatic switch.

However, an IP telephone device in the form of a conventional desktop telephone device does not include a standard operating system for a personal computer or a PDA or the like, and therefore, it does not allow a softphone, which operates on such operating system, to be installed therein. Thus, it has a problem in that it is more difficult to respond to the various needs of individual users and their changing needs as compared to softphones. When responding to such needs, it will be necessary to develop and manufacture hardware, or skill for developing a special operating system will be required. Furthermore, there is a problem in that it is not easy to install and use commonly-used software other than a telephone function, and to make the linkage between the telephone function and such software in the telephone.

Also, in a commonly-used personal computer, a softphone can be introduced and used, but the form of the entire device is different from that of a commonly-used telephone device, and accordingly, there are problems in that: a person who is familiar with the form of a conventional telephone device feels a sense of discomfort, and takes much trouble and time to make a phone call; and a larger space is required for placing the device on a desk compared to a desktop telephone device. In particular, where the device is made available to the general public, for example, in a conference room or hotel, it is problematic because it cannot be recognized as a telephone at a glance. Also, it has no components essential for a desktop telephone device such as a receiver, a hook switch that detects the receiver being on the hook or off the hook, and push buttons that are arranged in a manner different from that of a computer's numeric keypad, as hardware, which is problematic in that it cannot be used as if it were a commonly-used telephone device. Also, the device has no multifunctional telephone device components such as line buttons, function buttons, e.g., those for hold and transfer, and digital response buttons whose functions can be changed according to a screen display in the display section, as hardware buttons, which is problematic in that it cannot be used as if it were a commonly-used multifunctional telephone device. Furthermore, conventionally, personal computers allow end users to install software and configure the settings, which are different from telephone devices, and accordingly, a problem may occur in ensuring the reliability and availability of softphone operation, depending on the skills of the end user.

Also, although some PDAs or the like and mobile phones are easy to make a phone call and allow installation of a softphone, they are problematic in that they are not suitable to be placed on a desk all the time because of their forms, and have no “multifunctional phone buttons”, which are useful in desktop telephone devices.

Also, in the telephone device described in Japanese Patent Laid-Open No. 2003-259000, each time the telephone device starts up, an application program is created in a server apparatus and is downloaded to the telephone device, which is problematic in that it requires time for processing.

Also, in the telephone device described in Japanese Patent Laid-Open No. 1994-176041, the computer function is not involved in the telephone function, which is problematic in that a softphone for a personal computer, or a PDA or the like cannot be installed and used.

### DISCLOSURE OF THE INVENTION

An object of the present invention is to provide a telephone device that can be used as if it were a commonly-used desktop telephone device, while including a standard operating system for a personal computer, or for a PDA or the like to allow installation and use of a softphone.

Also, another object of the present invention is to provide a telephone device that can be used as if it were a commonly-used desktop telephone device, while including a standard operating system for a personal computer, or for a PDA or the like to allow installation and use of software other than a softphone.

In order to achieve the above objects, the present invention provides a telephone device including push buttons and a display section on a panel surface at an upper part of a housing, and a receiver connected via a wire or wirelessly connected to the housing, the receiver being placed on the housing when the device is not in call mode, characterized in that: the housing is constructed so that the receiver can be placed thereon and also constructed in the form of a desktop telephone device that can be placed on a desk; and the telephone device comprises a hook switch that is provided at the upper part of the housing and which detects an off-hook state in which the receiver is picked up from the housing, and an on-hook state in which the receiver is placed back on the housing, and a computer section connected to the bush buttons, the display section and the receiver via predetermined interfaces, the computer section being configured to include an operating system for a personal computer or a PDA to allow installation of an IP softphone operating on the operating system, and to provide a communication and phone call function via the IP softphone.

Also, the telephone device is characterized by comprising at least a part of keys set as a standard for a computer keyboard, and a pointing device, on the panel surface at the upper part of the housing.

Also, the telephone device is characterized in that the telephone device comprises at least a part of keys set as a standard for a computer keyboard, on the panel surface at the upper part of the housing; and the display section is a touch panel.

Also, the telephone device is characterized in that the computer section is configured to allow installation of software, other than the IP softphone, that will run on the operating system for a personal computer or a PDA.

Also, the telephone device is characterized by comprising, on the panel surface at the upper part of the housing, a line button section indicating use of a line, a function button section for setting a phone call function, or a digital-response button section for executing a function displayed on the display section.

In the present invention configured as described above, an operating system for a personal computer, or a PDA or the like is installed in the computer section to allow a user or an operation administrator to install an IP softphone (softphone that communicates according to the Internet Protocol), which will run on the operating system, and this IP softphone provides communication and phone call functions, and furthermore, while a user or an operation administrator can install and use a softphone and software other than the softphone, which will run on the operation system, a housing including, on its upper panel surface, a telephone operation section including push buttons and a display section, which are connected to the computer section via predetermined interfaces, is constructed so that the receiver can be placed thereon and is also constructed in the form of a desktop telephone device that can be placed on a desk, and thus can be used as if it were a commonly-used telephone device.

### BRIEF DESCRIPTION OF THE DRAWINGS

FIG. 1 is a schematic overview of an embodiment of a telephone device according to the present invention;

FIG. 1b is a diagram illustrating a configuration of a panel surface of the telephone device shown in FIG. 1a;

FIG. 2 is a diagram illustrating a configuration of a computer section, which is shown in FIG. 1, focusing on the hardware configuration;

FIG. 3 is a diagram illustrating a configuration of the computer section shown in FIG. 1 focusing on the software;

FIG. 4a is a diagram illustrating a connection between a telephone device according to the present invention, an IP exchange and a business system server;

FIG. 4b is a diagram illustrating a connection between a telephone device according to the present invention, an IP exchange and a business system server;

FIG. 4c is a diagram illustrating a connection between a telephone device according to the present invention, an IP exchange and a business system server; and

FIG. 4d is a diagram illustrating a connection between a telephone device according to the present invention, IP exchanges and business system servers.

### BEST MODE FOR CARRYING OUT THE INVENTION

Hereinafter, an embodiment of the present invention will be described with reference to the drawings.

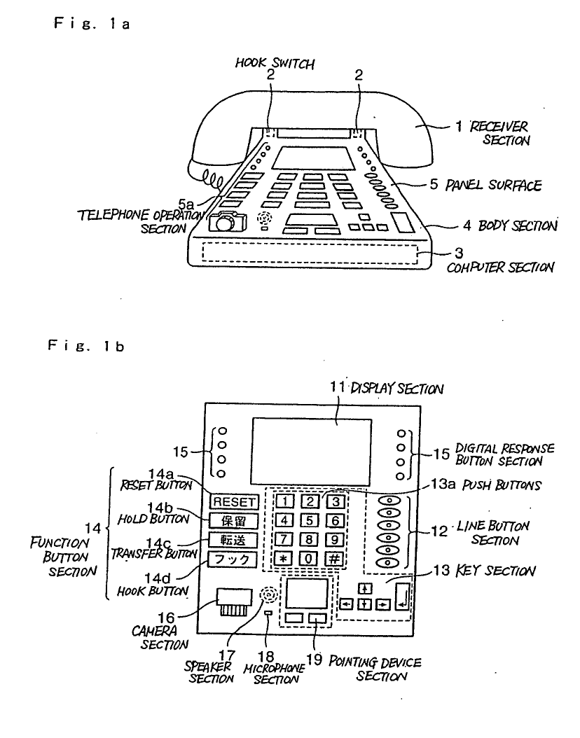

FIG. 1a is a schematic overview of an embodiment of a telephone device according to the present invention, and FIG. 1b is a diagram illustrating the configuration of panel surface 5 of the telephone device shown in FIG. 1a.

The present embodiment, as shown in FIG. 1a, includes: body section 4 formed by a housing in the form of a desktop telephone device, which is placed on a desk, and receiver section 1 connected via a wire or wirelessly to body section 4. Body section 4 includes telephone operation section 5a on panel surface 5 at the upper part of the housing, and computer section 3 connected to receiver section 1 and telephone operation section 5a in the inner part of the housing. Receiver section 1 is configured so that it can be placed on a recess formed in body section 4, and is placed on the recess when it is not in call mode. This recess is provided with hook switches 2 for detecting an off-hook state in which receiver section 1 is picked up, and an on-hook state in which receiver section 1 is placed back thereon. An off-hook/on-hook signal indicating this off-hook state or on-hook state is output to computer section 3 via an interface such a USB. Also, an IP softphone, which performs communication according to the Internet Protocol, is installed in computer section 3, which will be described later.

Also, as shown in FIG. 1b, panel surface 5 of body section 4 is provided with display section 11, line button section 12, key section 13, function button section 14, digital response button section 15, camera section 16, speaker section 17, microphone section 18 and pointing device section 19.

Display section 11 is a liquid-crystal display or a liquid-crystal touch panel. Where display section 11 is a liquid-crystal touch panel, pointing device section 19 can be omitted.

Line button section 12 includes a plurality of buttons indicating use of lines, and is connected to computer section 3 via an interface such as a USB, and receives inputs from, and performs outputs to, an external interface of the softphone. More specifically, it receives a line button lighting-up/lighting-out signal, etc., from the softphone as an input, and delivers a line button depression signal to the softphone as an output.

Key section 13 includes push buttons 13a for dialing, in which only the keys that are mainly used when a phone call operation is performed using the softphone, such as direction keys and a return key, etc., from among the keys set as a standard for a computer keyboard, are arranged. Whereas the arrangement is different between the push buttons of a telephone device and the numeric keys of a computer, the telephone device push button arrangement is employed. As described above, the push buttons are mainly arranged and necessary keys selected from the keys set as a standard for a computer keyboard are also arranged, whereby an appearance, size and operability closer to those of a telephone device rather than those of a computer can be provided. Also, where a standard computer keyboard is used, a USB keyboard is connected to a USB interface of computer section 3 and used.

Function button section 14 includes reset button 14a, hold button 14b, transfer button 14c and hook button 14d for setting call functions. Function button section 14 is connected to computer section 3 via an interface such as an USB, and receives inputs from, and performs outputs to, an external interface of the softphone, and sends function button depression signals to the softphone as outputs. Reset button 14a forcibly returns the device to a predetermined state when a user wishes to make a phone call regardless of the device state.

Digital response button section 15 is connected to computer section 3 is connected to via an interface such as USB, receives inputs from and performs outputs to the external interface (API) of the softphone, and sends digital response button depression signals to the softphone as outputs. A plurality of digital response buttons included in digital response button section 15 are provided in regions adjacent to display section 11. This is because the functions of the digital response functions are displayed in the parts of display section 11 adjacent to the digital response buttons by means of the softphone, and also, the display is changed according to the state of the softphone to enable understanding of the meaning of the digital response between depression signals. Consequently, the functions displayed in display section 11 can be executed by depressing the digital response button included in digital response button section 15.

Camera section 16 is connected to computer section 3 via an interface such as a USB, and it is used when the softphone or application software is linked with a camera for a videophone/videoconference function, etc.

Speaker section 17 is connected to an audio output of computer section 3, and microphone section 18 is connected to an audio input of computer section 3.

Pointing device section 19 is a pointing device corresponding to a touch pad/mouse, etc., and is connected to computer section 3. As described above, where display section 11 is a touch panel, pointing device section 19 can be omitted.

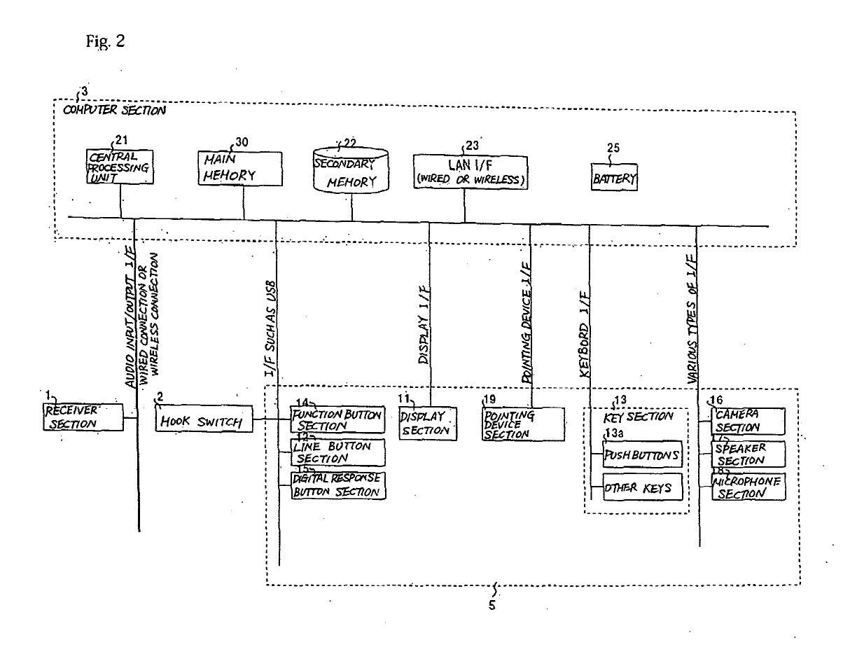

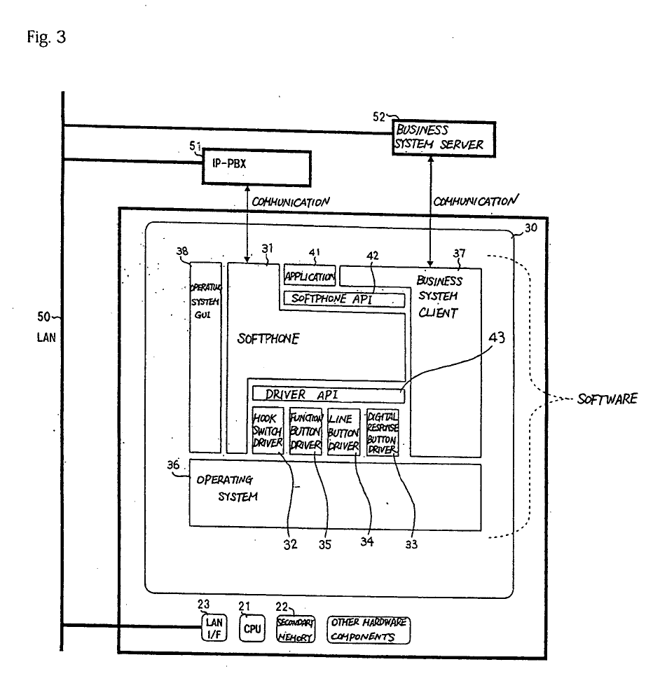

FIG. 2 is a diagram illustrating the configuration of computer section 3 shown in FIG. 1 focusing on the hardware configuration, and FIG. 3 is a diagram illustrating the configuration of computer section 3 shown in FIG. 1 focusing on the software.

Computer section 3 shown in FIG. 1, as shown in FIG. 2, includes central processing unit 21, main memory 30 and secondary memory 22, which are necessary for the operation system for a personal computer or a PDA or the like to operate. Also, it includes a LAN interface 23 for Ethernet and is connected to a network via a LAN.

Computer section 3 is connected to push button 13a via a standard keyboard interface for a personal computer/PDA or the like, and also is connected to display section 11 via a standard display interface for a personal computer/PDA or the like. Furthermore, it is connected to pointing device section 19 via a standard pointing device interface for a personal computer/PDA or the like. Where display section 11 is a touch panel, operating system 36 (see FIG. 3) and display section 11 are connected via a standard pointing device interface for a personal computer/PDA.

Main memory 30 shown in FIG. 2, as shown in FIG. 3, includes operating system 36 for a personal computer, or PDA or the like, which allows installation and use of softphone 31. Examples of the operating system for a personal computer include Windows, Linux and Mac-OS. Also, examples of the operating system for a PDA or the like include Windows CE, Windows Mobile, Palm OS, Symbian and Linux. Although part of them is sometimes called operating systems for smart phone, it is included in the operating systems for a PDA or the like in this description. Main memory 30 also includes GUI 38 for the operating system, which enables a user to access and use the operating system. This point is also different from conventional desktop telephone devices. This enables work such as installation of a softphone, which will be described later, and also enables installation and use of software other than softphone, application software.

Softphone 31 is an IP softphone that communicates with an IP exchange according to the Internet Protocol. Thus, audio communication (telephone) and data communication between computers and servers can be provided solely by the aforementioned LAN cable, and do not require a conventional telephone line cable. Also, a softphone that suits the needs of a user or an operation administrator can be installed.

Main memory 30 also includes hook switch driver 32, digital response button driver 33, line button driver 34 and function button driver 35, which are connected to hook switches 2, digital response button section 15, line button section 12 and function button section 14 via a general-purpose interface such as a USB, and receive/send signals from/to them as described above.

Dedicated business system client 37, which operates on the operating system for a personal computer, or a PDA or the like can be installed and used. Depending on the business system, the Web browser on the operating system for a personal computer, or a PDA or the like may be used as a client.

Providing the aforementioned configuration and exposing driver API 43, which functions as an interface for hook switch driver 32, digital response button driver 33, line button driver 34 and function button driver 35 to developers, enables the developers to develop a softphone linked with these components, or a component for linking the existing softphone and these components with each other.

Also, where the softphone to be installed includes exposed application interface (softphone API) 42, an application developer can develop application 41 that is linked with the softphone in a telephone device, or can link the softphone and business system client 37 in a telephone device.

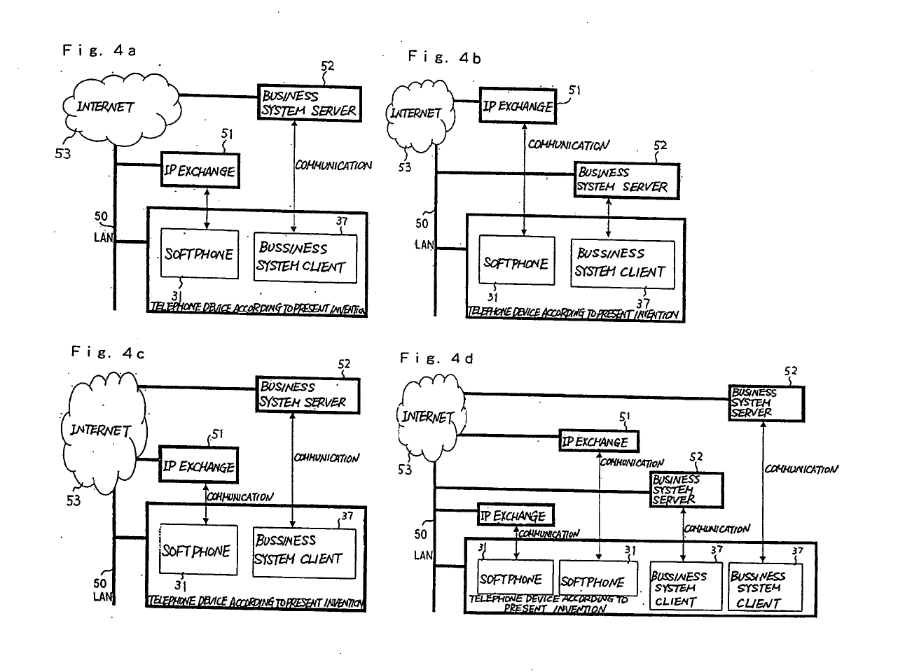

Furthermore, as shown in FIG. 3, softphone 31 and business system client 37 can communicate with IP exchange 51 and business system server 52 via LAN 50. Also, as shown in FIGS. 4a, 4b and 4c, softphone 31 and business system client 37 can communicate with either or both IP exchange 51 and business system server 52 via the Internet, and also, as shown in FIG. 4d, plural different softphones 31 and plural different business system clients 37 can be installed and used. Depending on the business system, the Web browser on the operating system for a personal computer, or a PDA or the like may be used as a client.

The operation of a telephone device having the aforementioned configuration will be described below.

### 1. Operation for Start Up and Termination

(1) Upon the device being connected to a power source, power supply to the entire device is started, operating system 36 starts up, and softphone 31 automatically starts up according to the settings. Upon completion of the start-up procedures of softphone 31, the device is ready (available).
(2) During the device being when the device is connected to the AC power source, battery 25 is charged.
(3) When the device is disconnected from the AC power source, the power supply is switched to power supply from battery 25 and shut down instructions are provided to operating system 36. Operating system 36 terminates softphone 31 and then terminates (shuts down) itself. Subsequently, the power supply to the entire device stops.
2. Operation when Making a Phone Call
(1) When receiver section 1 is picked up, an off-hook signal is conveyed from hook switches 2 to softphone 31 via an interface such as a USB and hook switch driver 32, and softphone 31 enters the state in which it can accept a telephone number input.
(2) Push buttons 13a are depressed to input a telephone number. Alternatively, a telephone number is selected by operating the screen for softphone 31, using a phonebook or dialed and received call records or the like. At that time, key section 13 such as direction keys and an ENTER key, and/or pointing device section 19 are used.
(3) According to the input or selected telephone number, softphone 31 calls IP exchange 51.
(4) By means of the exchange function of IP exchange 51, the device is connected to the telephone device on the callee side.
(5) Conversation can be conducted using softphone 31. When function button 14 is depressed, a function button depression signal is conveyed to softphone 31 via an interface such as a USB, and thus, a function of softphone 31 such as hold, transfer or trilateral talk can be used.
(6) Where softphone 31 has functions that enable calls involving images such as videotelephone and videoconference, such functions can be used by means of camera section 16, which is connected to softphone 31 via an interface such as a USB.
(7) When receiver section 1 is put down, an on-hook signal is conveyed from hook switches 2 to softphone 31 via an interface such as a USB and hook switch driver 32, and softphone 31 performs processing for call termination on IP exchange 51.
3. Operation when Receiving a Phone Call
(1) When a phone call is received, softphone 31 is notified by the exchange that a call has been received, by means of a function of softphone 31. Softphone 31 generates a ringing sound via speaker section 17 connected to an audio output of computer section 3. Softphone 31 conveys a line button blinking signal to line button section 12 via line button driver 34 and an interface such as a USB to make line button section 12 blink.
(2) When receiver section 1 is picked up, an off-hook signal is conveyed from hook switches 2 to softphone 31 via an interface such as a USB and hook switch driver 32. Then, softphone 31 communicates with IP exchange 51, and enters call mode. Depending on the settings, it is necessary for a user to depress a line button before entering call mode after picking up receiver section 1. When a line button is depressed, a line button depression single is conveyed to softphone 31 via the interface such as a USB and line button driver 34.
(3) Conversation can be conducted using softphone 31. The functions of softphone 31 such as hold, transfer and trilateral conference can be used. At that time, depending on the function, the user may depress function button section 14 or digital response button section 15. When function button section 14 is depressed, a function button depression signal is conveyed to softphone 31 via an interface such as a USB and function button driver 35, and softphone 31 executes the function corresponding to the depressed button. When digital response button section 15 is depressed, a digital response button depression signal is conveyed to softphone 31 via an interface such as a USB and digital response button driver 33, and softphone 31 executes the function corresponding to the depressed button.
(4) When softphone 31 has the functions that enable calls involving images such as videotelephone and videoconference, such functions can be used by means of camera section 16 connected to softphone 31 via an interface such as a USB.
(5) When receiver section 1 is put down, an on-hook signal is conveyed from hook switches 2 to softphone 31 via an interface such as a USB and hook switch driver 32, and softphone 31 performs processing for call termination on IP exchange 51.
4. Operation of Software Other than Softphone
(1) Software 37 and 41 other than the softphone can be started using pointing device 19 and key section 13 such as the direction keys and the ENTER key, while confirming the status by means of display section 11. Alternatively, the settings can be made so that a designated one of software 37 and 41 other than the softphone can automatically be started at the time of start-up of the entire device.
(2) Software 37 and 41 other than the softphone can be used using pointing device 19 and key section 13 such as the direction keys and the ENTER key, while confirming the status by means of display section 11. Software 37 and 41 other than the softphone can communicate with remote business system server 52 via a LAN.
(3) Software 37 and 41 other than the softphone can be terminated using pointing device 19 and key section 13 such as the direction keys and the ENTER key, while confirming the status by means of display section 11. Alternatively, software 37 and 41 other than the softphone is terminated by means of operating system 36 at the time when the entire device is stopped as a result of being disconnected from the power source.

Since the present invention has the configuration described above, it can be used as if it were a commonly-used desktop telephone device, or a multifunctional telephone device that is a desktop telephone device having function buttons, line buttons and digital response buttons, etc., while including an operating system for a personal computer, or a PDA or the like to enable a user or an operation administrator to install and use a softphone and/or software other than the softphone, which operates on the operating system.

The advantageous effects of the capability of installing a softphone include the following.

Softphones have constantly been advancing to develop new functions one after another, and have high capability of linkage with IT systems (groupware and business systems). These advanced functions of a softphone can be used with a human interface close to a conventional telephone device. Also, where an individual user has its own needs, it is possible to respond to such needs by altering a softphone according to the needs of that user, or by developing auxiliary software for calling the API (application interface) of the softphone. Thus, there is no need for hardware development and production, and skills for development on a special operating system.

Also, a softphone, as with a conventional multifunctional telephone device, is constructed so that it can be connected to a specific version of a specific exchange, and cannot always be connected to another type of exchange or another version of the same exchange. In the present invention, a softphone and a device to operate it are separated, and accordingly, the device according to the present invention can be used as a telephone terminal for a different type of an exchange or for a different version of the same exchange by a user or by an operation administrator's simple replacement of softphones. As a result, the users can reduce the telephone device replacement needs, the distributors can reduce the stock, and the manufacturers can suppress the investment in production facilities.

Applying these effects, for example, it is possible that a telephone device according to the present embodiment can be installed in a hotel, an office for rent, an event site, etc., and different types of softphones can be used depending on the users. For example, for a telephone device installed in a guest room in a hotel, before the check-in of a guest belonging to a company having a special contract with the hotel, a change is made to the telephone device in the guest room so that the softphone based the extension exchange of that company can be used, and also a communication environment such as a VPN is set, remotely from the front desk. As a result, the telephone device installed in the guest room is incorporated into the extension exchange in the company to which the guest belongs, enabling the guest to communicate in a manner similar to when he/she is in the office.

Also, the advantageous effects of the form of a telephone device include the following.

Users of desktop telephone devices and organizations using such devices have culture and custom that allow desktop telephone devices to occupy some areas of the users' desk spaces and also to be on for 24 hours (supplied with power). A telephone device according to the present invention gives no sense of discomfort in the aforementioned office environment and custom because it has the form of a desktop telephone device, and in addition, the space for setting the device can be secured separately from a business personal computer or a laptop computer.

As a result, it becomes possible to separate the operation of a business personal computer and the operation of a telephone device according to the present invention, enabling enhancement of the reliability and availability of a softphone arising from the operation. In other words, for business computers, it is possible to employ the operation mode in which a user (end user) mainly perform the work such as software installation or setting changes as in the currently-common practice, while for a telephone device according to the present invention, it is possible to employ the operation mode close to a conventional telephone device, in which the device includes an operation system for a personal computer, or a PDA or the like and an operation administrator or a person in charge performs the work such as software installation, setting changes and operation checks (remotely, depending on the case). This conforms to the culture and custom of end users mainly performing the management work such as installation and setting changes for computers, and administrators mainly performing the management work such as installation and setting changes for telephone devices. As a result, while using a softphone, an administrator can collectively perform the management work such as softphone replacements when the softphone is upgraded, the settings for the softphone is changed or the exchanges are replaced, or the exchange service provider is switched to another, enabling strengthening the ensuring of a normal operation.

Also, advantageous effects of the capability of installing/using software other than a softphone include the following.

Provision of an information screen for, from among conventional computer programs, particularly those having an informative nature and a real-time nature to a telephone device according to the present invention, the device having a form that does not give a sense of discomfort in being placed on an area of a desk and being up for 24 hours, results in enhancement of the capability of giving information to users.

For example, streaming distribution software, news distribution software and a business system report screen (for sales flash report, etc.), various kinds of alert (warning) display programs including that for security may be used for information. Although such information can be provided on a business computer screen, in many cases, a user is in the middle of other work such as word processing on the business computer. Thus, the user does not check the report screen, etc., having an informative nature at a sufficient frequency, and if the report screen is forcibly displayed, the user's mental concentration on the ongoing work will be impaired. Such problem can be improved by displaying such computer system informative screen on a telephone device according to the present invention.

Also, since a telephone device according to the present invention includes an operating system for a personal computer, or a PDA or the like, a engineer or a company having the skills to develop a computer system (a manufacturing system, a distribution system, a financial system, a government office system, etc.) can regard this telephone device as a component of a computer-centered business system and can develop the entire system so that part of the software making up the system operates on this telephone device.

Also, the advantageous effects of the capability of installation/use of both a softphone and software other than the softphone include the following.

Many of softphones for a personal computer, or a PDA or the like have an API for input/output from/to another program. In an telephone device according to the present invention, software other than a softphone, for example, a phonebook program, a voice mail program, a terminal program for conferences involving images such as videoconference and Web conference, groupware or client software for a business system such as sales or accounting can be installed, and the softphone and the software other than the softphone can be linked with each other by the aforementioned API. For example, they can be linked with each other so that a user can make a phone call by means of a simple operation from information displayed on software other than the softphone. Also, where software called application sharing and a softphone are linked with each other, it is possible to have the person at the other end of the line see or operate the screen that a user is viewing. A user can make such link via a telephone device.

1. A telephone device including push buttons and a display section on a panel surface at an upper part of a housing, and a receiver connected via a wire or wirelessly to the housing, the receiver being placed on the housing when the device is not in call mode, characterized in that:
the housing is constructed so that the receiver can be placed thereon and is also constructed in the form of a desktop telephone device that can be placed on a desk; and
the telephone device comprises
a hook switch that is provided at the upper part of the housing and detects an off-hook state in which the receiver is picked up from the housing and an on-hook state in which the receiver is placed on the housing, and
a computer section connected to the bush button, the display section and the receiver via predetermined interfaces, the computer section being configured to include an operating system for a personal computer or a PDA to allow installation of an IP softphone operating on the operating system, and providing a communication and phone call function via the IP softphone.

2. The telephone device according to claim 1, further comprising at least a part of keys set as a standard for a computer keyboard, and a pointing device, on the panel surface at the upper part of the housing.

3. The telephone device according to claim 1, wherein
the telephone device comprises at least a part of keys set as a standard for a computer keyboard, on the panel surface at the upper part of the housing; and
the display section is a touch panel.

4. The telephone device according to claim 1, wherein
the computer section is configured to allow installation of software, other than the IP softphone, operating on the operating system for a personal computer or a PDA.

5. The telephone device according to claim 1, further comprising
a line button section indicating use of a line, a function button section for setting a phone call function, or a digital-response button section for executing a function displayed on the display section, on the panel surface at the upper part of the housing.
